(19) United States
(12) Patent Application Publication
(10) Pub. No.: US 2025/0284469 A1
(43) Pub. Date: Sep. 11, 2025

(54) METHOD TO DISPLAY OBJECTS IN A VISIBLE REGION

(71) Applicant: Delta Electronics, Inc., Taoyuan City (TW)

(72) Inventors: MAO-HUA CHENG, Taoyuan City (TW); YUNG-LIANG CHANG, Taoyuan City (TW); PING-CHING WANG, Taoyuan City (TW)

(21) Appl. No.: 18/597,950

(22) Filed: Mar. 7, 2024

(51) Int. Cl. G06F 8/34; G06F 3/04847; G06F 8/41

(52) U.S. Cl. CPC G06F 8/34; G06F 3/04847; G06F 8/427

(57) ABSTRACT

The present invention relates to a method and a system to display objects of a visual-based programmable logic controller (PLC) language. The method comprises identifying objects to be displayed in a visible region of a canvas based on a content index, calculating the actual object height and the actual object width of the objects, adjusting predicted canvas height and predicted canvas width of the canvas, and displaying the objects in the visible region. This method may shorten the time taken to display objects in a visible region after the system opens a visual programming language file while preserving flexibility to display the objects in a more user-friendly manner for a visual-based programming language file with massive amount of content.

### BACKGROUND OF THE INVENTION

### Field of the Invention

The present invention relates to methods and systems to display at least one object of a visual programming language file in a visible region for a visual-based programmable logic controller (PLC) language with massive amount of content.

### Description of Related Art

A visual programming language or block-based coding language can be compiled into hardware codes to be identified and executed by a computer, e.g., a desk computer, a tablet computer, an industrial computer, a programmable logic controller (PLC), etc. For industrial automation applications, the visual programming language allows programmers to visualize a series of operations and processes into at least one of a ladder diagram (LD), sequential function chart (SFC), continuous function chart (CFC), and function block diagram (FBD). For gaming and animation applications, a series of motions, dialogues, sound and visual effects that are performed by one or more characters can be edited into a visual programming language file. Many software products, such as CODESYS®, TwinCAT®, Snap!®, Scratch®, have been developed for the programmers to create, inspect or edit the contents of a visual programming language file, without writing textual coding commands.

As manufacturing processes or animation scenes become more and more intricate, the content of the visual programming language file could be massive. Sometimes, it takes a long time and a great amount of hardware resources to open the visual programming language file, which is inconvenient to the programmers.

Therefore, it is desirable to develop a method to open the visual programming language file with massive amount of content with least time and hardware resources.

### SUMMARY

This application provides a method for displaying a portion of a visual programming language file having multiple objects arranged in multiple sections. The method comprises steps of: (1) establishing a content index from the visual programming language file; (2) obtaining and storing information related to at least one visible object in at least one visible section to be displayed in a visible region of the canvas into the content index; (3) calculating a predicted canvas height and a predicted canvas width of the canvas based on the content index; and (4) displaying the at least one visible object in the visible region.

This application provides a display system for displaying a portion of a visual programming language file having multiple objects arranged in multiple sections. The display system comprises a display device, a user interface, a memory device, and a processor. The display device is configured to display an image corresponding to at least one visible object in a visible region of a canvas. The user interface is configured to receive a user command. The memory device is configured to store the visual programming language file, a content index of the visual programming language file, and a program code. The processor is connected to the display device, the user interface and the memory device, wherein the program code is configured to instruct the processor to perform operations comprising steps of: (1) establishing the content index from the visual programming language file; (2) obtaining and storing information related to the at least one visible object in at least one visible section to be displayed in a visible region of the canvas into the content index; (3) calculating a predicted canvas height and a predicted canvas width of the canvas based on the content index; and (4) displaying the at least one visible object in the visible region.

Other objectives, advantages and novel features of the invention will become more apparent from the following detailed description when taken in conjunction with the accompanying drawings.

### BRIEF DESCRIPTION OF THE DRAWINGS

FIG. 1 is an example of a visual programming language file written by ladder diagram.

FIG. 2 is a flow chart describing one embodiment of a process for displaying a portion of a visual programming language file according to one embodiment of the disclosure.

FIG. 3 is a schematic diagram illustrating the structure of a content index according to one embodiment of the disclosure.

FIG. 4 shows a flow chart describing one embodiment of sub-steps of establishing a content index according to one embodiment of the disclosure.

FIG. 5 is an example of a visual programming language file written by ladder diagram.

FIG. 6 shows a flow chart describing an example of sub-steps to identify one or more potential visible sections and obtain and store a horizontal object number, a vertical object number, and related object structural information of each of the one or more potential visible sections into a content index according to one embodiment of the disclosure.

FIG. 7 is a schematic diagram illustrating the structure of a content index according to one embodiment of the disclosure.

FIG. 8 is an example of a visual programming language file written by ladder diagram.

FIG. 9 shows a flow chart describing one embodiment of sub-steps to obtain and store information related to at least one visible object into a content index according to one embodiment of the disclosure.

FIG. 10 shows a flow chart describing an example of steps to perform sub-steps to obtain and store information related to at least one visible object into a content index according to one embodiment of the disclosure.

FIG. 11 is an example of a portion of a visual programming language file in a visible region, and a structure of a corresponding read state stored in a content index.

FIG. 12 shows a flow chart describing one embodiment of sub-steps to calculate a predicted canvas height and a predicted canvas width of a canvas according to one embodiment of the disclosure.

FIG. 13 shows a flow chart describing an example of sub-steps to calculate a predicted canvas height and a predicted canvas width of a canvas according to one embodiment of the disclosure.

FIG. 14 is an example of a visual programming language file written by ladder diagram.

FIG. 15 shows a flow chart describing one embodiment of sub-steps to display the at least one visible object in a visible region according to one embodiment of the disclosure.

FIG. 16A and FIG. 16B are schematic diagrams of a visible region with scrolling bars according to some embodiments of the disclosure.

FIG. 17 is an example of a visual programming language file written by ladder diagram.

FIG. 18 is a schematic diagram illustrating the structure of a content index for a new visible region according to one embodiment of the disclosure.

FIG. 19 is an example of a visual programming language file written by ladder diagram.

FIG. 20 is a functional block diagram of a display system according to one embodiment of the disclosure.

### DETAILED DESCRIPTION OF PREFERRED EMBODIMENTS

The terminology used in the description presented below is intended to be interpreted in its broadest reasonable manner, even though it is used in conjunction with a detailed description of certain specific embodiments of the technology. Certain terms may even be emphasized below; however, any terminology intended to be interpreted in any restricted manner will be specifically defined as such in this Detailed Description section.

The described embodiments concern one or more methods, systems, apparatuses, and computer readable mediums storing processor-executable process steps for displaying at least one object of a visual programming language file in a visible region based on a content index. The disclosed systems and methods are developed for users to create, inspect or edit the contents of a visual programming language file.

The visual programming language file comprises multiple sections, and the multiple objects are arranged in the multiple sections. The content index stores a structural information of the visual programming language file, such as a total section number and multiple section indexes. Each section index may include a horizontal object number, a vertical object number and a structure relationship of these objects. On one hand, the disclosure enables a quick display of a portion of the visual programming language file in a visible region because the system does not need to parse and draw all the objects at the beginning. On the other hand, the disclosure enables a more comprehensive display of the objects, which includes more information in a format easier to be understood.

The visual programming language file is a software file written by a visual-based programming language. In one embodiment, the visual-based programming languages may be any programmable logic controller (PLC) language employing graphs to describe logic structure between objects, such as ladder diagram (LD), sequential function charts (SFC), function block diagram (FBD), and the like. A programmable logic controller (PLC) language is a programming language used to describe logic structure for electromechanical systems executed by the industrial controllers. In one embodiment, a section may further comprise a section label object, and/or a section comment object.

A visual programming language file comprises multiple objects. Like a building block, an object is an element of a visual-based programming language, representing a specific electronic/mechanical control logic of a system component to build the logic structure of an electromechanical system.

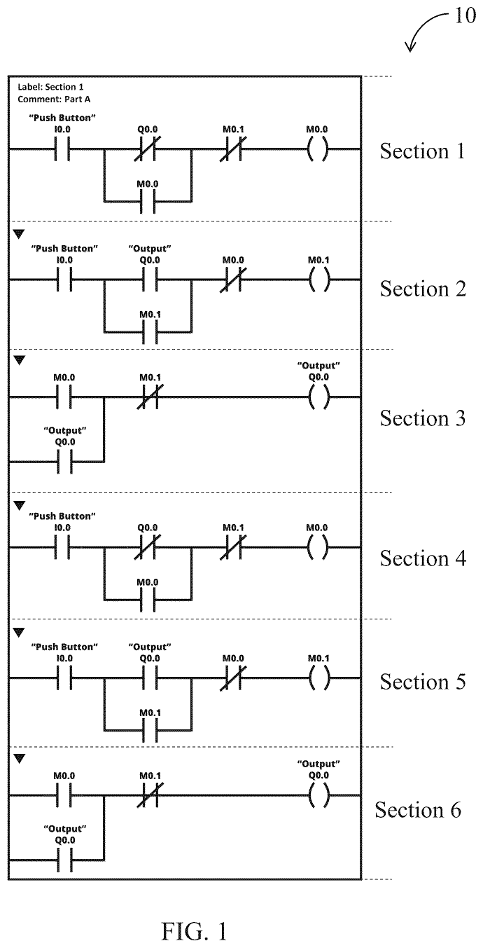

For example, ladder diagram (sometimes called “ladder logic”) is a popular programming language to record logic structures for industrial controls. The language is called ladder diagram because the graphs mimic a ladder with two vertical rails (supply power) and as many “rungs” (horizontal lines) as there are to represent control circuits. This symbology is sometimes used to demonstrate the interconnection of electromechanical switches and relays. In this programming language, an object may be a ladder logic symbol, such as normally open contact (NO), normally closed contact (NC) symbols, output coil symbol, comparison symbols and the like. FIG. 1 is an embodiment of a visual programming language file written by ladder diagram. It should be noted that, in the visual programming language file 10 in the example shown in FIG. 1, the multiple objects are strictly arranged in the 2-dimensional space, and the objects are connected by straight or elbow lines. However, in some applications and embodiments, the objects may be arbitrarily arranged, and thus the processor reads the object information including a location, a width, a height, and a rotational angle of the object. In some applications and embodiments, objects of a visual programming language file may be arranged in a 3-dimensional space, and thus the processor reads the object information including a location, a width, a height, a depth, and a normal direction of the object, in which the normal direction describes a rotational angle relative to a normal direction of the 3-dimensional space.

The disclosed systems and methods may be implemented by software written by various programming languages, such as C #, C++, Java, Python, Objective-C, and the like. When an object-oriented programming language is employed, programming objects may be utilized to implement the content index and various functions. Such programming objects are different from the objects of a visual programming language file to be displayed in a visible region by the disclosed systems and methods. However, the content index may also be implemented by other data structures, such as database.

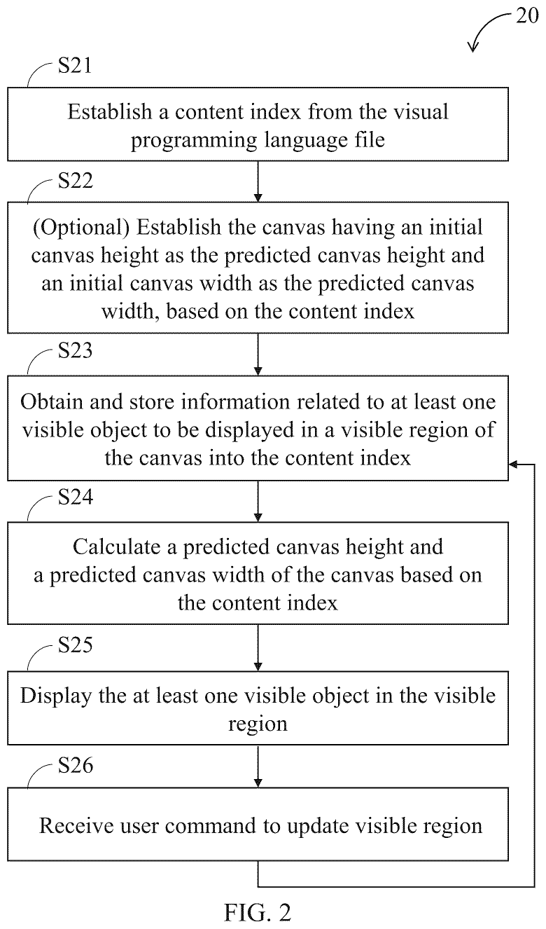

FIG. 2 depicts a flow chart describing one embodiment of a method for displaying a visual-based programming language file at the first time and thereafter when a user opens the visual programming language file according to one embodiment of the disclosure. The method 20 may be compiled into a program code for instructing a processor to execute following steps.

In brief, in step S21, the system establishes a content index from the visual programming language file. In step S22, the system establishes a canvas having an initial canvas height as a predicted canvas height and an initial canvas width as a predicted canvas width, based on the content index. Then in step S23, the system obtains and stores information related to at least one visible object to be displayed in a visible region of the canvas into the content index. In step 23, the system calculates a predicted canvas height and a predicted canvas width of the canvas based on the content index. Then the system displays the at least one visible object in the visible region in step S26. If the system receives a user command to update visible region, the system may first determine the location of the new visible region on the current canvas in step S26. Then the system may repeat steps S23 to S25 to display the at least one visible objects in a new visible region. In another embodiment, step 22 may be skipped.

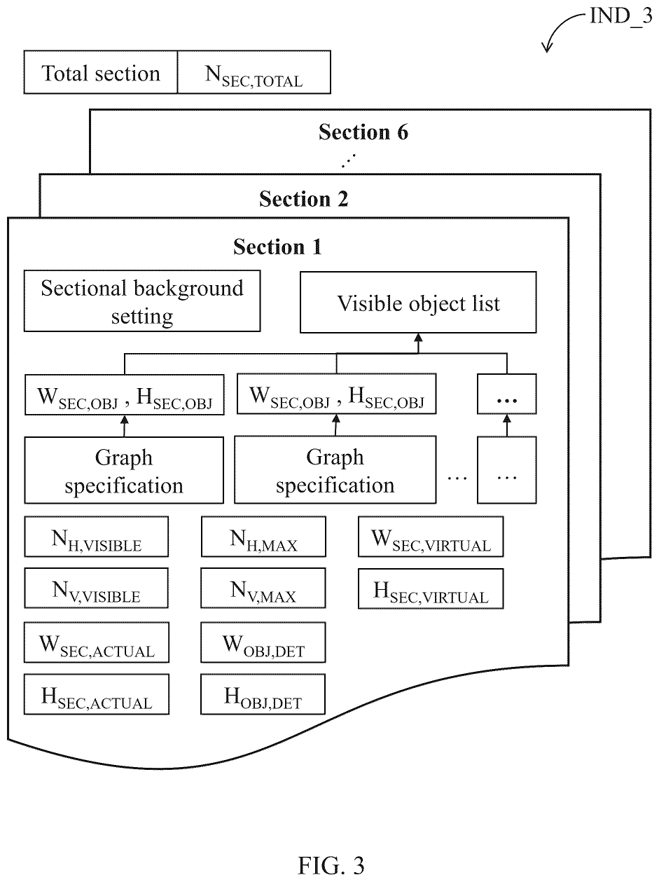

FIG. 3 depicts a schematic diagram of a structure of a content index according to one embodiment of the disclosure. As shown in FIG. 3, the content index IND_3 may comprise object information (e.g., object information such as object type, object comment, input or output variables, location, object width, object height, default object height and default object width), and statistics information (e.g., vertical object number and horizontal object number, visible vertical object number and visible horizontal object number, or total section number), wherein a little amount of memory device is required to store the lightweight content index. Since the content index may only comprise information related to the current visible object, the information stored in the content index is increased as a user determines new portion(s) of visual programming language file to be displayed. It should be noted that because making the content index only involves simple logics and counts, a very short time is required even if the visual programming language file includes massive content. Therefore, the visual programming language file can be displayed in short time and require less hardware resources. Experiments show that loading times of visual programming language files with massive and little content are approximately the same. That is to say, in the disclosure, the loading time for displaying visual programming language files with massive and little content is approximately constant and irrelevant to file size.

When the content index is first established in S21, the content index may only comprise a total section number representing the number of all sections in the visual programming language file. When the system parses a first visible section as the at least one visible section, for example section 1, the structural information of the multiple objects for such section, such as a horizontal object number and a vertical object number of the section is derived as a section index which is stored in the content index. After the system calculates the actual object height and the actual object width of the at least one visible object to be displayed in the visible region, such object information is stored in the content index. The content index may also include displaying information for a specific display in a visible region. Such displaying information may be updated or removed in the process of another display in a new visible region.

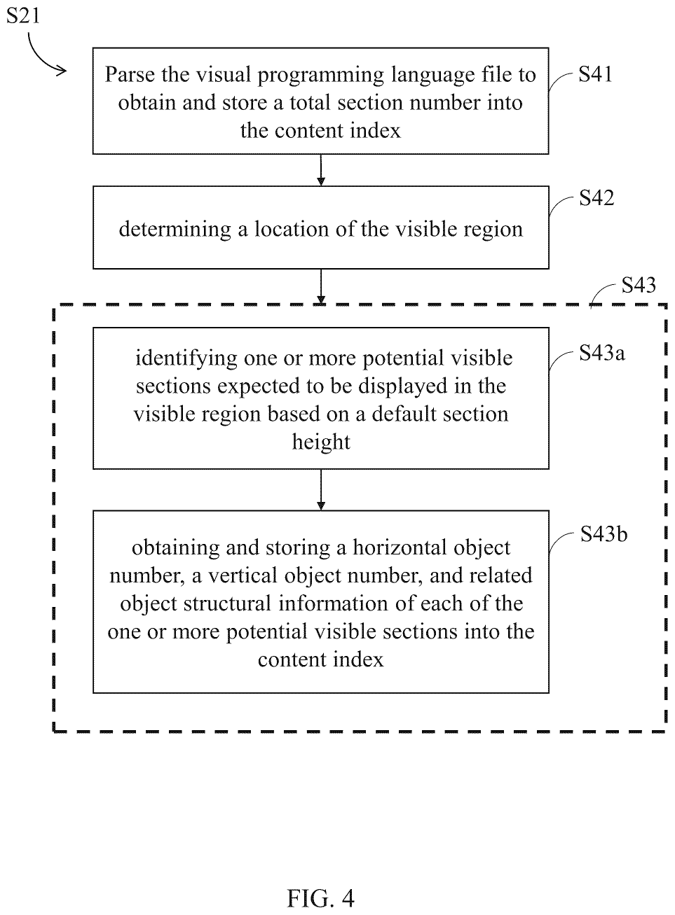

In step S21, the system establishes a content index from a visual programming language file in one of various file formats. Step S21 may further comprises steps S41 to S43 as shown in FIG. 4. The visual programming language file may comprise multiple sections, and each section may comprise multiple objects. Referring to FIG. 4, in step S41, when a user opens a visual programming language file or a file comprising a visual programming language file to be displayed, the system may establish an empty content index, and parse the visual programming language file to obtain and store a total section number into the content index. For example, for the visual programming language file 10 as shown in FIG. 1, the system may parse the visual programming language file 10 to obtain the total section number of 6, and store into the content index. In one embodiment, the file and/or the visual programming language file is remarked in the Extensible Markup Language (XML) file format. In one embodiment, a file may comprise multiple visual programming language files written by one or more programming languages, and one of which is the visual programming language file to be displayed. In such case, the system may first review contents of the file to identify different programming language parts. For example, file part one is written by ladder diagram, file part two is written by sequential function charts, and file part three is written by function block diagram. The system may determine which is the visual programming language file to be displayed first by default setting or user input. The contents of the visual programming language file may also be referred to as lines of codes of such file. A content index is established to store the total section number and the related information (e.g. default settings such as a default section height, a default section width, a default object height, or a default object width; section number) from the visual programming language file. In one embodiment, the content index can be in XML format. In one embodiment, the content index may be implemented as a programming object based on the class structure or other data structure in C #, C++, Java, Objective-C, or any other suitable programming language.

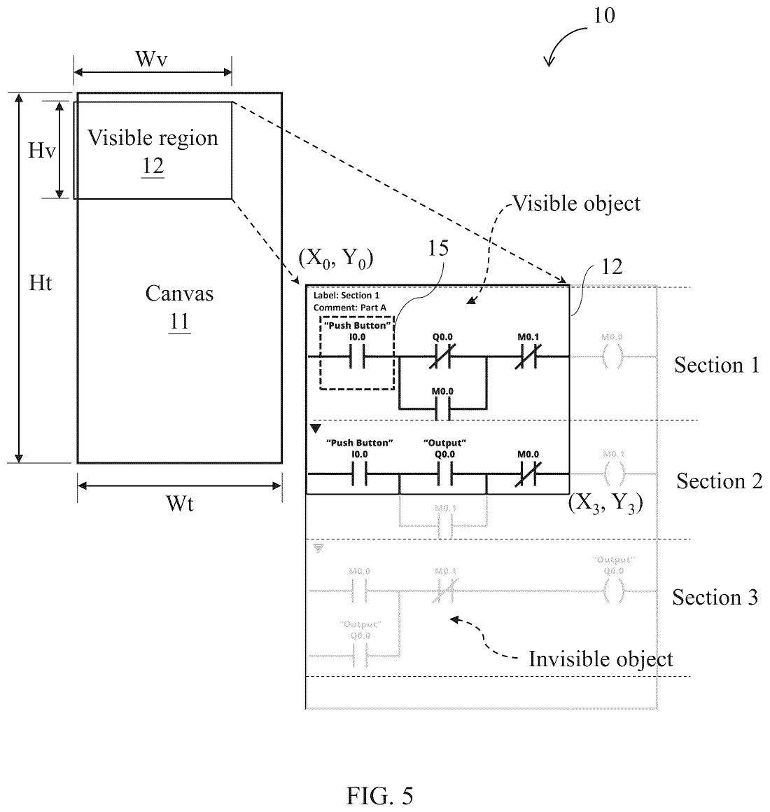

In step S42, the system may determine a location of the visible region. In one embodiment, the location of the visible region on a canvas may be determined by a coordinate of a representing point, e.g. the upper left vertex, a height and a width. The system may determine a height and a width of a visible region in an embodiment where the visible region is a rectangle, by default setting or by user input before or after the visual programming language file is opened. Alternatively, the location of the visible region may be determined by coordinates of the four vertices. FIG. 5 depicts a schematic diagram of the visible region of a canvas to display a visual programming language file according to one embodiment of the disclosure, wherein the visual programming language file 10 may be substantially similar to the visual programming language file 10 shown in FIG. 1. In the example as shown in FIG. 5, an origin and a diagonal vertex of the visible region 12 are (X₀, Y₀) and (X₃, Y₃), respectively. The width Wv is calculated by (X₃−X₀), and the height Hv is calculated by (Y₃−Y₀) when the origin (X₀, Y₀) is (0,0), and the diagonal vertex (X₃, Y₃) is (Wv, Hv).

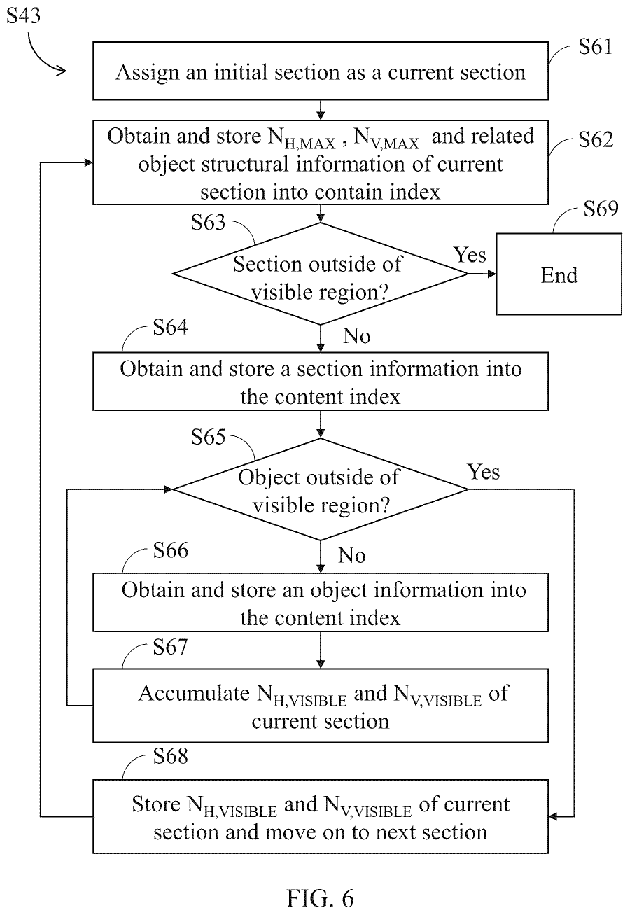

In step S43, the system may identify one or more potential visible sections expected to be displayed in the visible region based on a default section height (S43a), and obtain and store a horizontal object number N_{H,MAX}, a vertical object number N_{V,MAX}, and related object structural information of each of the one or more potential visible sections into the content index (S43b). The horizontal object number N_{H,MAX} is the largest number of the objects arranged in horizontal direction in a section, and the vertical object number N_{V,MAX} is the largest number of objects arranged in vertical direction in a section. In one embodiment, the related object information may record the manner the objects in the current section are connected, e.g. in series or in parallel, and/or the order these objects are connected. In one embodiment, the connection relationship of objects is managed by assigning each object an object ID. In another embodiment, step S43 and subsequent steps may be formed later as part of step S22 or S23. Besides from the potential visible sections, the system may also obtain the horizontal object number, the vertical object number and the related object structural information of all the other sections of the visual programming language file in step S43. Step S43 may further comprises steps S61 to S69 as shown in FIG. 6.

In step S61, the system may assign an initial section as a current section. In one embodiment, the first section of the visual programing language file can be the initial section. For example, Section 1 of the visual programming language file 10 shown in FIG. 5 can be the initial section.

In step S62, the system parses the current section of the visual programming language file to obtain the horizontal object number N_{H,MAX}, the vertical object number N_{V,MAX}, and the related object structural information of the current section. For example, as shown in FIG. 5, the horizontal object number N_{H,MAX} and the vertical object number N_{V,MAX} of Section 1 in the visual programming language file 10 is 4 and 2, respectively. Along a horizontal direction X, a first row of Section 1 includes four objects, a second row of Section 1 includes one object, and thus the horizontal object number N_{H,MAX} of Section 1 is four. Along a vertical direction Y, each of a first, third and fourth column of Section 1 includes one object, a second column of Section 1 includes two objects, and thus the vertical object number N_{V,MAX} of Section 1 is two. However, the system can adapt any other suitable algorithm to calculate the horizontal object number and the vertical object number.

Then in step S63, the system verifies whether the current section is outside of the visible region. In one embodiment, each section has a same default section height at the beginning. As a result, each section may be assigned a vertical coordinate, such as Y coordinate, to represent the vertical location of such section. For example, when the default section height is 2 pixel units, the vertical coordinate of the first section, the second section, and the third section is respectively 0, 2, and 4 pixel units. In an embodiment where the size of a visible region is 3 pixel units (height)×6 pixel units (width), the Section 1 and Second 2 are verified to be in the visible region while Section 3 is verified to be outside of the visible region.

If the current section is not outside (i.e., completely or partially inside) of the visible region, the system may obtain and store a section information into the content index in step S64. An empty section index for each section may be established beforehand, and the section information may be stored into the section index. In one embodiment, if a section includes a section label object, and/or a section comment object in the visible region, the related contents of these objects (e.g. the text of the section label object and/or the section comment object) described in the visual programming language file may also be parsed and stored into the corresponding section index. For example, in the embodiment shown in FIG. 5, the Section 1 includes a section label object and a section comment object, both of which are in the visible region. The related contents of these objects (e.g. the text of the section label object) described in the visual programming language file may be stored into the section index of Section 1. However, since the section label object and a section comment object of Section 2 is not set to be displayed, the system may not obtain the related content.

In step S65, the system may assign an object in the current section as a current object, and determine whether the object is outside of the visible region. If the current object is not outside of the visible region, the system obtains and stores the object information of the current object into the content index in step S66, and accumulates a visible horizontal object number and a visible vertical object number of the current section in step S67. The object information of an object may comprise type, comment text and input/output variables, and can be stored into the section index of the section where the object is located. The visible horizontal object number of a section is the largest number of the visible objects arranged in horizontal direction in the section, and the visible vertical object number of the section is the largest number of the visible objects arranged in vertical direction in the section. Then, the system may assign the next object in the current section as the current object, and repeat steps S65 to S67 until the current object is outside of the visible region or there is no more object to be parsed in the current section. In step S68, the accumulated visible horizontal object number N_{H,VISIBLE} and the visible vertical object number N_{V,VISIBLE} of the current section is stored into the content index, and move on to the next section of the visual programming language file. The system may repeat steps S62 to S68 until the current section is outside of the visible region or there is no more section in the visual programming language. For example, as shown in FIG. 5, when parsing Section 1, the system may determine the object 15 as the current object at the beginning, and obtain and store the object information into the content index. The object information of the object 15 may comprise the comment of “Push Button”, a variable of “IO.0”, and a type of “open contact”. After repeating steps S65 to S67 until all object in the visible region are parsed, the system may store the visible vertical object number of 2, and the visible horizontal objection number of 3 into the section index of Section 1, and move on to Section 2. Steps S62 to S68 are repeated again for Section 2, while only steps S62 and S63 are executed for Section 3 because it is outside of the visible region.

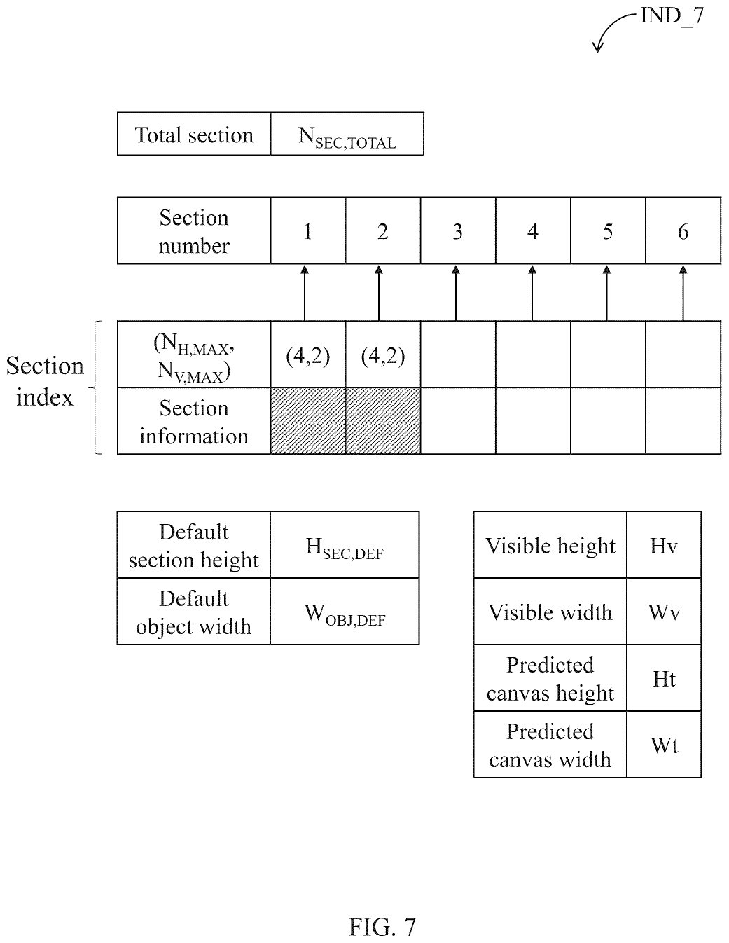

FIG. 7 depicts a schematic diagram of a structure of a content index IND_7 according to an embodiment of the disclosure. The content index IND_7 is established for the visual programming language file 10 after Step S21 has been executed. As shown in FIG. 7, each of section information related to Section 1 and Section 2 is parsed and stored in the content index IND_7 as a section index because each of them has a portion inside of the visible region 12. On the other hand, information related to Section 3 to Section 6 is not parsed and stored into content index because they are outside of the visible region 12. Please be noted that a block in the content index IND_7 refers to an allocated memory device space or register(s) during step execution, in which a block filled with dash pattern stores data, and an empty block does not store data.

In another embodiment, the system may parse all the sections in the visual programming language file in step S21 to obtain a section index comprising a section information for each section and store the section indexes into the contain index.

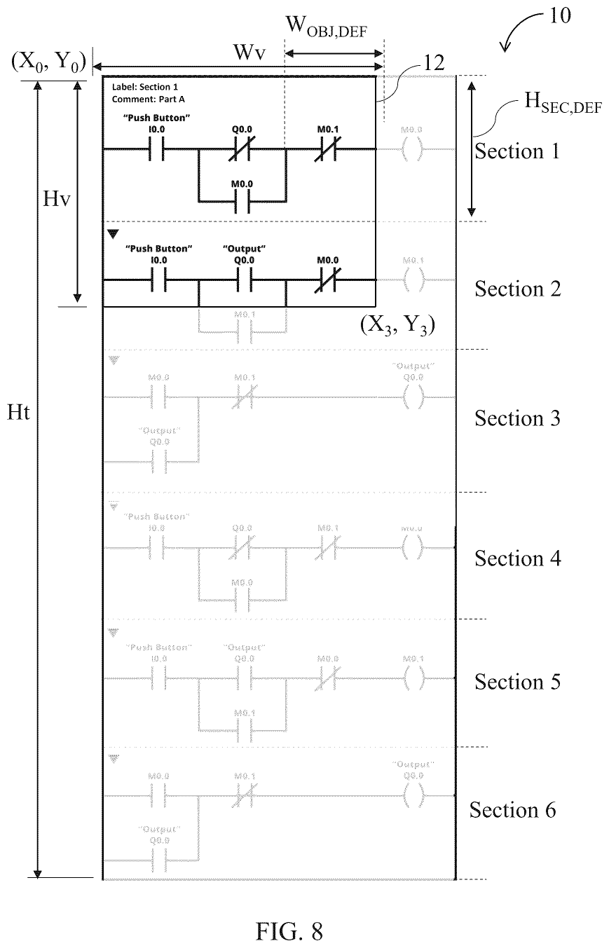

In Step S22 as shown in FIG. 2, a canvas having an initial canvas height as the predicted canvas height and an initial canvas width as an initial canvas width as the predicted canvas width, based on the content index may be established. The initial canvas height and initial canvas width may be calculated in various manners. For the initial canvas height, at least three embodiments are available. In first embodiment, the initial canvas height is a default canvas height, which can be determined by default setting or user input. Thus, no calculation is necessary. In second embodiment, the initial canvas height Ht equals to the total section number N_{SEC,TOTAL} of the visual programming language file multiplied by the default section height H_{SEC,DEF} (i.e., Ht=H_{SEC,DEF}*N_{SEC,TOTAL}). In the example as shown in FIG. 8, when the visual programming language file has a total section number N_{SEC,TOTAL} of 6, and the default section height H_{SEC,DEF} is 80 pixel units, the initial canvas height Ht is 80*6=480 pixel units. In third embodiment, in Step S21, the system already identifies one or more potential visible section, and the vertical object number is stored in the content index. Then, in Step S22, the system calculates the initial canvas height taking account of the vertical object number N_{V,MAX} of the potential visible sections. Thus, for the calculation of the initial canvas height, the potential visible sections use a predicted section height that equals to the default object height H_{OBJ,DEF} multiplied by the vertical object numbers N_{V,MAX}, while the other sections use the default section height H_{SEC,DEF}. For example, the visual programming language file has 6 sections, 2 of which are the potential visible sections. The vertical object number is respectively 2 and 3 for the potential visible sections, the default section height is 3 pixel units, and the default object height is 2 pixel units. Then the initial canvas height is 22 pixel units. In one embodiment, the section height further needs to be added a default section label height, a default section comment height and a default section frame height; however, a person skilled in the art may modify the definition of the section height according to practical requirements.

For the initial canvas width, at least two embodiments are available. In first embodiment, the initial canvas width is the default canvas width. Thus, no calculation is necessary. In second embodiment, in Step S21, the system already identifies one or more potential visible section, and the horizontal object number is stored in the content index. Then, in Step S22, the system calculates the initial canvas width Wt taking account of the horizontal object number of the potential visible sections. The predicted section width of each visible section equals to the horizontal object number N_{H,MAX} multiplied by the default object width W_{OBJ,DEF} (i.e., Wt=W_{OBJ,DEF}*N_{H,MAX}). The initial canvas width is the largest predicted section width for all the potential visible sections. For example, if the horizontal object number N_{H,MAX} is respectively 5 and 8 for 2 potential visible sections, and the default object width W_{OBJ,DEF} is 100 pixel units. Then the initial canvas width Wt is 800 pixel unit (8*100). However, in one embodiment, if all the predicted section width of the potential visible sections are smaller than the default canvas width, the system may determine the default canvas width as the initial canvas width. It should be understood that the total height Ht and the total width Wt of the canvas 11 will be updated once the relative size of the visible region 12 is adjusted by the programmer, and then converge to an actual height and an actual width of the canvas 11 as the file 10 is exploring by the programmer.

In one embodiment, after the initial canvas height and the initial canvas width are determined, a scrolling bar may be generated based on the size and the position of the visible region relative to the canvas. In addition to scrolling bar, other user interfaces may be provided for users to determine the position of the visible region for displaying sections and objects of the visual programming language file. For example, a small preview image of the canvas may provide an overview of the entire canvas and allow the user to click or drag to select the visible region. Arrow icons for moving the visible region up, down, left, and right are alternatives as well.

In Step 23 as shown in FIG. 2, the system obtains and stores information related to at least one visible object to be displayed in the visible region of the canvas into the content index. In one embodiment, the information related to at least one visible object may comprise a section index comprising an actual height and an actual width of each of the at least one visible object. In one embodiment, the information related to at least one visible object may comprise object information of each of the at least one visible object.

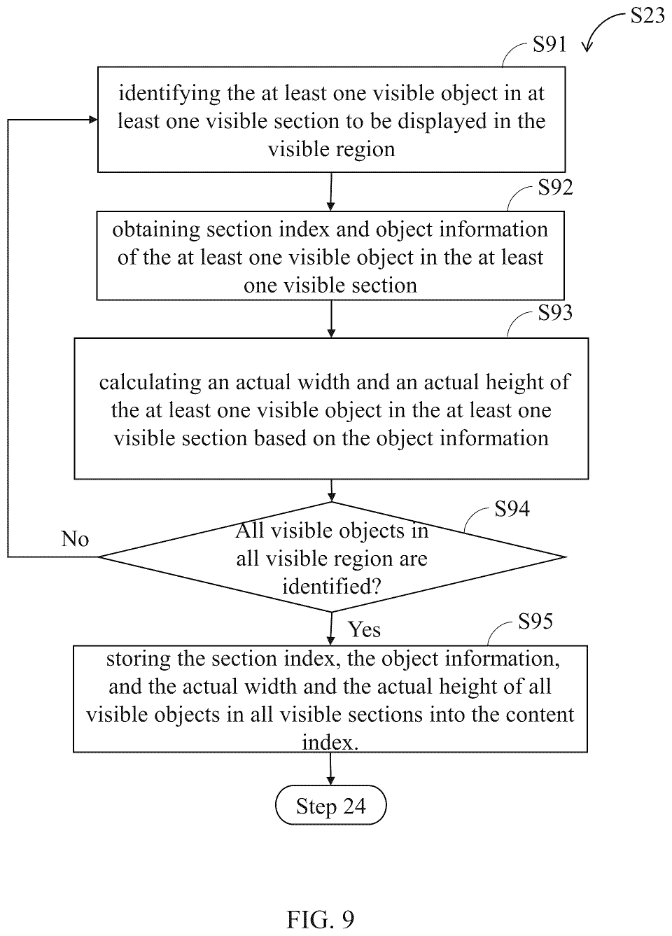

Step S23 may further comprise steps S91 to S95 as shown in FIG. 9. In step S91, the system identifies at least one visible object in at least one visible section to be displayed in the visible region. In one embodiment, the system may determines a vertical coordinate of the visible region on the canvas. Then, a predicted vertical coordinate of the multiple sections is calculated based on the content index. The system may identify the at least one visible section having a predicted vertical coordinate corresponding to the vertical coordinate of the visible region on the canvas. In one embodiment, to first identify the at least one visible section, the predicted vertical coordinate of a section is calculated by adding up a predicted section height of each section before the section, the predicted section height of an unparsed section is a default section height, and the predicted section height of a parsed section is a sum of a predicted row height of each row in the parsed section. The predicted row height of a row without a displayed object is a default object height, and the predicted row height of a row with at least one displayed object is the largest actual object height. Alternatively, the predicted vertical coordinate of a section may be calculated by adding up a predicted section height of each section before the section wherein the predicted section height is the default section height. That is, for Section 3, the predicted vertical coordinate may be 2 times the default section height. In one embodiment, to identify the at least one visible object, the system determines a horizontal coordinate of the visible region on the canvas, and calculates a predicted horizontal coordinate and a predicted vertical coordinate of the multiple objects in the at least one visible section based on the content index. The at least one visible object having a predicted horizontal coordinate and a predicted vertical coordinate is identified corresponding to the horizontal coordinate and the vertical coordinate of the visible region on the canvas. The predicted vertical coordinate of an object in one of the at least one visible section is calculated by adding up a predicted section height of each section before the section and a predicted row height of each row before the object in the section. Each section is a parsed section or an unparsed section. The predicted section height of an unparsed section is a default section height, and the predicted section height of a parsed section is a sum of a predicted row height of each row in the parsed section. The predicted row height of a row without a displayed object is a default object height, and the predicted row height of a row with at least one displayed object is the largest actual object height. Alternatively, the predicted vertical coordinate of an object in one of the at least one visible section is calculated by adding up a total section height of the sections before the section and a total row height of the rows before the object in the section. The total section height of the sections before the section can be the default section height times the number of sections before the section where the object in. The total row height can be the default row height times the number of rows before the object in the section. It should be noted that the system may also take account of the section label height and/or the section comment height when calculating the predicted vertical coordinate of the at least one visible object and the predicted vertical coordinate of the at least one visible section in some embodiments. For example, when the section label object and the section comment object of Section 1 is in the visible region, the vertical coordinate of the Section 2 is the sum of the section label height, the section comment height, and the predicted section height of Section 1.

Then in step S92, the system obtains section index and object information of the at least one visible object in the at least one visible section. It should be understood that if the section index or the object information is obtained and stored into the content index before (for example, in step S21), the system may skip step S92. In step S93, the system calculates an actual width and an actual height of the at least one visible object in the at least one visible section based on the object information. The system may repeat steps S91 to S94 until all visible objects in all visible sections are identified if the at least one visible object includes multiple visible objects and the at least one visible section includes multiple visible sections.

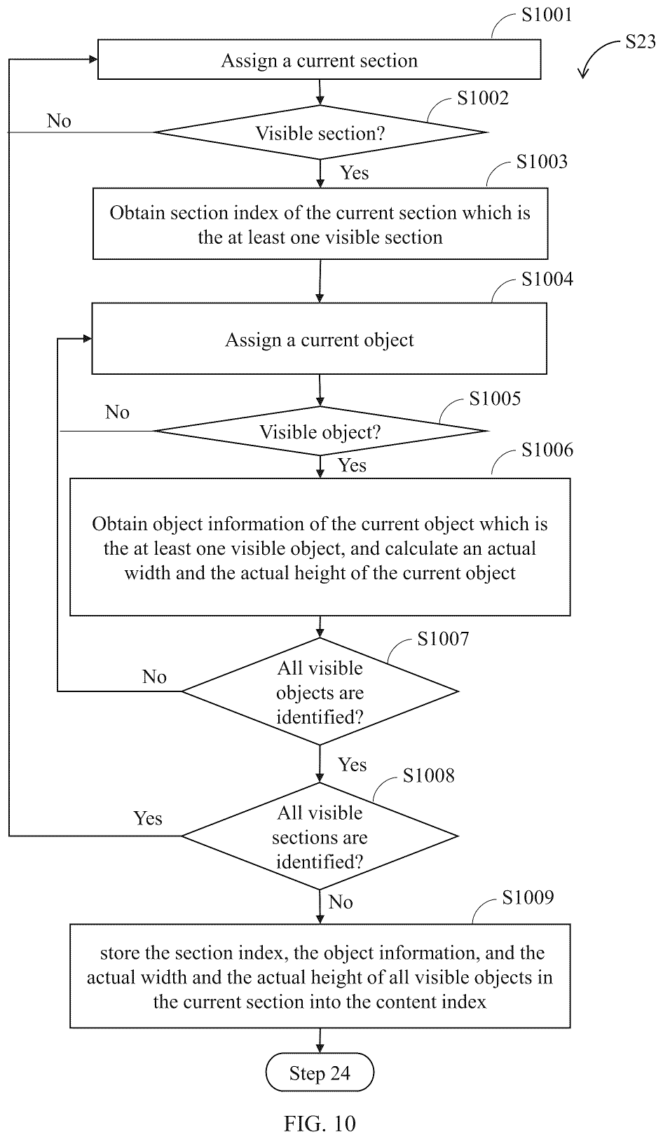

FIG. 10 depicts an example of a process flow to perform a method comprising steps S91 to S95 according to one embodiment of the disclosure. In step S1001, the system may assign a current section. At the beginning of step S23, the system may first assign an initial section as the current section. In one embodiment, the system may assign the first section of the visual programming language file as the initial section. Then in step S1002, the system may determine if the current section is outside of the visible region. If so, the system returns to step S1001 to assign the next section as the current section; otherwise, the system determines the current section as a visible section and proceed to step S1003. In one embodiment, if the system determines a section as a visible section, it may add the section into a visible section list in step S1002. The visible section list is established in the content index to record the visible sections for this visible region, and may be released from the memory if the user updates the visible region to a new location. Each visible section in the visible section list may be completely or partially displayed in the visible region. As described above, the system may make such determinations based on the predicted vertical coordinate of the current section and the vertical coordinate of the visible region. For example, the vertical coordinate of the visible region is 3 pixel units, the height of the visible region is 6 pixel units, and the section height of each section is the default section height of 2 pixel units because there is no section parsed before. The system first assigns Section 1 as the current section, and determine it is not a visible section. Then, the system may assign the next section, Section 2, as the current section, and determine it is a visible section, and proceed to step S1003.

In step S1003, the system obtains the section index of the current section which is the at least one visible section, and store it into the content index. The section index may comprise the horizontal object number and the vertical object number of the current section. In one embodiment, the section index may further comprise a section information, which may be substantially similar to the one described above with regard to step S64, and the related details are omitted here for brevity. However, if the section index of the current section has been obtained before and already stored in the content index, step S1003 may be skipped in one embodiment.

In step S1004, the system assigns an object in the current section as a current object. The system may assign an initial object in the current section as a current object when performing step S1004 for the first time for the current section. In one embodiment, the system may assign the first object of the current section as the initial object. Then, the system may determine if the current object of the current section is outside of the visible region in step S1005. In one embodiment, the system may determine based on the predicted coordinate of the current object as described before. If the system determine the current object is in the visible region and hence be a visible object, the system may proceed to step S1006; otherwise, the system returns to S1004 to assign the next object as the current object. In one embodiment, if the system determines an object as a visible object, it may add the object into a visible object list in step S1005. The visible object list is established in the content index to record the visible objects for the visible region, and may be released from the memory when the user update the visible region to a new location. Each visible object in the visible object list may be completely or partially displayed in the visible region. In one embodiment, the object ID is used for the visible object list.

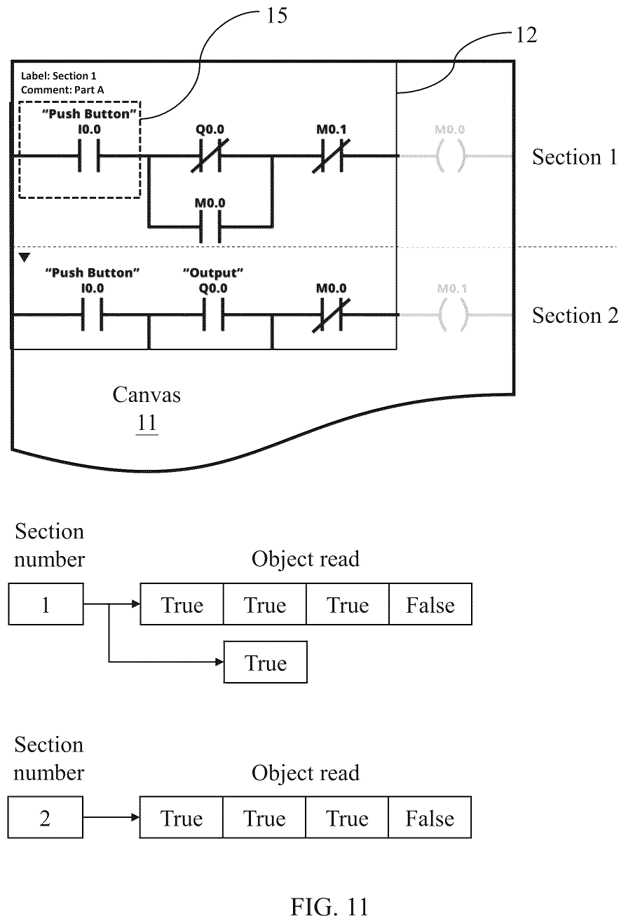

In step S1006, the system may obtain an object information of the current object which is one of the at least one visible object, and calculate an actual width and an actual height of the current object. The object information, such as the object type, the object name, the object comment, and the input or output variables may be retrieved, and the object information may be stored in the content index. However, if the object information of the current object has been obtained before and already stored in the content index, this step may be omitted in one embodiment. The system calculates the actual height and the actual width of the current object based on the object information. In one embodiment, the system may generate a graphic specification for the current object based on the object information. The graph specification may includes the actual height, the actual width, an object type, an object name, an input variable, and an output variable of the current object. The graph specification of the current object may be stored into the content index. For example, the graph specification comprises a graphic data object and a location of the graphic data object. In one embodiment, the graphic data object may specify the brightness and/or the color of each pixel to be rendered to generate an image of the object. In addition, each object may be assigned a predicted two-dimensional coordinate, such as (X,Y) to represent the predicted location of a representing point, such as the top left point, of each object. Thus, the object coordinate, the actual object height, and the actual object width may determine the predicted area of the object on the canvas. Alternatively, 4 coordinates of the four vertices in case the object is of rectangular shape may be used to determine the predicted area of the object on the canvas. In one embodiment, after the actual height and actual width of an object are obtained, the system may set a read state of the object to be true. In one embodiment, a read state of the current section is set to be true if all the objects in the section are parsed. In one embodiment, the system may accumulate an actual section width and the actual section height, which respectively represents the width and the height of the visible part of the section. For example, as shown in FIG. 11, if the object 15 is the current object, the processor may obtain the object information including the comment of “Push Button”, a variable of “IO.0”, and a type of “open contact” and generate a graphic specification for it. Then, the system obtains its actual width and actual height, and identify the location where the object in. The actual section width W_{SEC,ACTUAL} and the actual section height H_{SEC,ACTUAL} is also accumulated, and a read state of the object is set to be true.

In S1007, the system may verify if all visible objects are identified. In one embodiment, the system calculates and determines whether there is any space left for displaying next object either in horizontal direction or in vertical direction in the visible region. In one embodiment, the system compares the actual width of the first visible object against the width of the visible region to determine whether the next object in the horizontal direction is displayed. The system also sequentially or in parallel compares the actual height of the first visible object against the height of the visible region to determine whether the next object in the vertical direction is displayed. In addition, when a visible object is the last object in a horizontal direction, the comparison in the horizontal direction ends. Similarly, when a visible object is the last object in a vertical direction of the last section, the comparison in the vertical direction ends. If there is still one or more visible objects in the current section haven't been identified, the system returns to S1004 and assigns a next object as the current object and repeats the steps S1004 to S1007 until all visible objects in the current section are identified.

If all the visible objects in the current section are identified, the system determines if all visible sections are identified in S1008. If not, the system may return to S1001 to assign the next section as the current section, and repeat S1001 to S1008 until all visible sections are identified.

In one embodiment, the system may also calculate a predicted section width and a predicted section height of the current section in S1007 if all visible objects in the current section are identified. The system may calculate the predicted section width by adding up a predicted object width of each object counted for the horizontal object number. Each object is either a displayed object or a non-displayed object. If the actual object width and the actual object height of an object are calculated before, the object is a displayed object; otherwise, the object is a non-displayed object. Hence, the predicted width of the displayed object is the actual object width, and the predicted width of the non-displayed object is a default object width. The system may calculate a predicted section height of the current section by adding up a predicted row height of each row in the current section. The predicted row height of a row without a displayed object is a default object height and the predicted row height of a row with at least one displayed object is the largest actual object height of the row.

Alternatively, in another embodiment, the system may obtain and store a visible horizontal object number and a visible vertical object number of the current section into the content index in step S1007 after the system determine all visible objects in the current section are identified. The visible horizontal object number of a section is the largest number of the visible objects arranged in horizontal direction in the section, and the visible vertical object number of the section is the largest number of the visible objects arranged in vertical direction in the section. Then, in step S1007, the system may calculate a virtual height and a virtual width of the current section, which is respectively the predicted height and the predicted width of the portion outside of the visible region. The virtual width of the section can be calculated by multiplying the default object width with a difference between the horizontal object number and the visible horizontal object number. For example, as shown in FIG. 8, Section 1 has a horizontal object number of 4 and a visible horizontal object number of 3. Hence, the virtual width of Section 1 is 1 times the default object width. Similarly, the virtual height of the section can be calculated by multiplying the default object height with a difference between the vertical object number and the visible vertical object number. For example, as shown in FIG. 8, Section 2 has a vertical object number of 2 and a visible vertical object number of 1. Hence the virtual height of Section 2 is 1 times the default object height.

If all visible sections are identified, the system may proceed to step S1009. The system stores the section index, the object information, and the actual width and the actual height of all visible objects in all visible sections into the content index. In another embodiment, each of the section index, the object information, the actual width and the actual height may be directly stored into the content index when being obtained, and step S1009 may be skipped. In one embodiment, the actual width, the actual height, the virtual width, and the virtual height of all visible sections may also be stored into content index. In another embodiment, each of the actual width, the actual height, the virtual width, and the virtual height of a visible section may be directly stored into the content index upon calculated in step S1007.

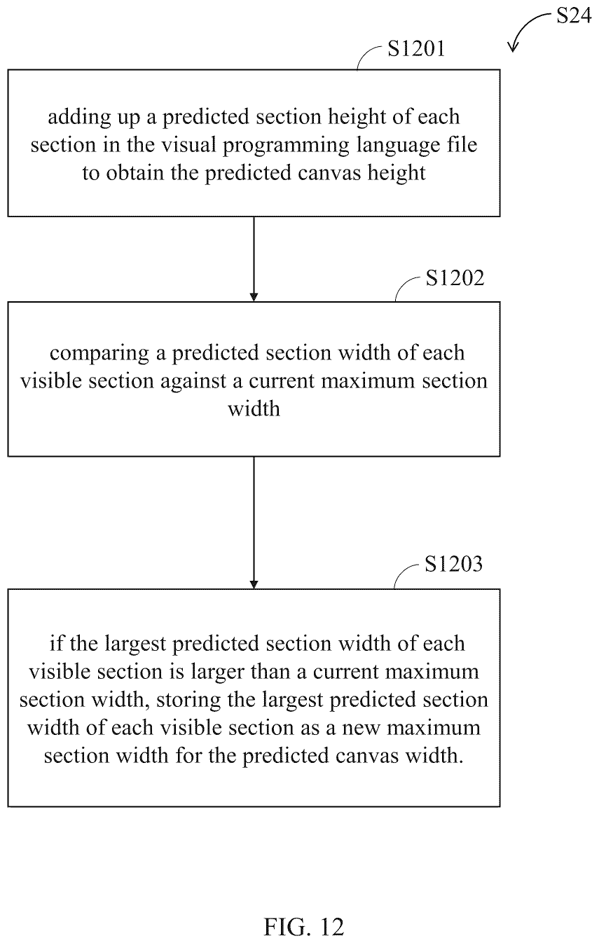

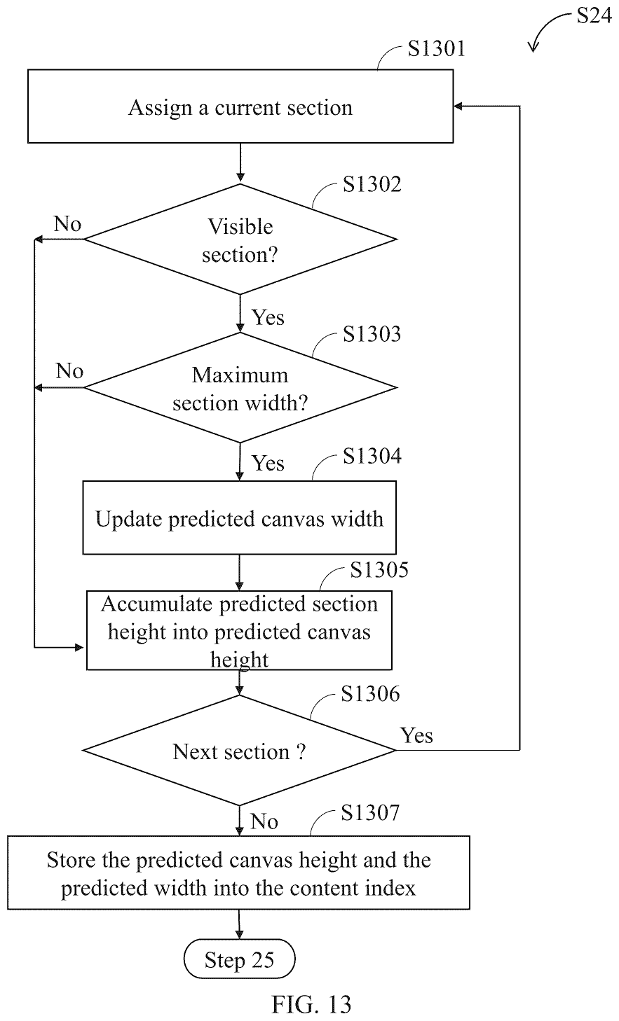

In step S24, the system calculates a predicted canvas height and a predicted canvas width of the canvas based on the content index. In one embodiment, step S24 may further comprise steps S1201 to S1203 as shown in FIG. 12. In step S1201, the system may add up a predicted section height of each section in the visual programming language file to obtain the predicted canvas height. In one embodiment, the predicted section height of a visible section is the sum of its actual section height and its virtual section width. Then step in S1202, the system may compare a predicted section width of each visible section against a current maximum section width. In one embodiment, the predicted section width of a visible section can be the sum of its actual section width and its virtual section width. If the largest predicted section width of each visible section is larger than a current maximum section width, the system stores the largest predicted section width of each visible section as a new maximum section width for the predicted canvas width in step S1203. FIG. 13 depicts an example of process flow to perform steps S1201 to S1203. In step S1301, the system may assign a section as a current section. For example, the system can assign the first section of the visual programming language file as the current section at the beginning. Then, the system may verify whether the section is a visible section (step S1302). If so, the system verifies if the predicted section width of the current section is the maximum section width against a current maximum section width in step S1303. It should be understood that at the first time, the system may compare the predicted section width with the initial canvas width, or directly assign the predicted section width of the current section as the maximum section width. If the predicted section width is larger, the system updates the predicted canvas width, and replaces the maximum section width with the predicted section width in step S1304. Then, the system accumulates the predicted section height of the current section into the predicted canvas height in step S1305. Then if there is a next section exists, the system may assign the next section as the current section, and repeat S1301 to S1306. If not, the system stores the predicted canvas height and the predicted canvas width into the content index in step S1307 and ends step S24. In another embodiment, the predicted section width and the predicted section height of each of the sections in the visual programming language file is respectively stored into a section width list and a section height list in the content index. Hence, the system may identify the largest predicted section width based on the section width list as the predicted canvas width, and calculate the predicted canvas height by adding up all the predicted section height in the section height list.

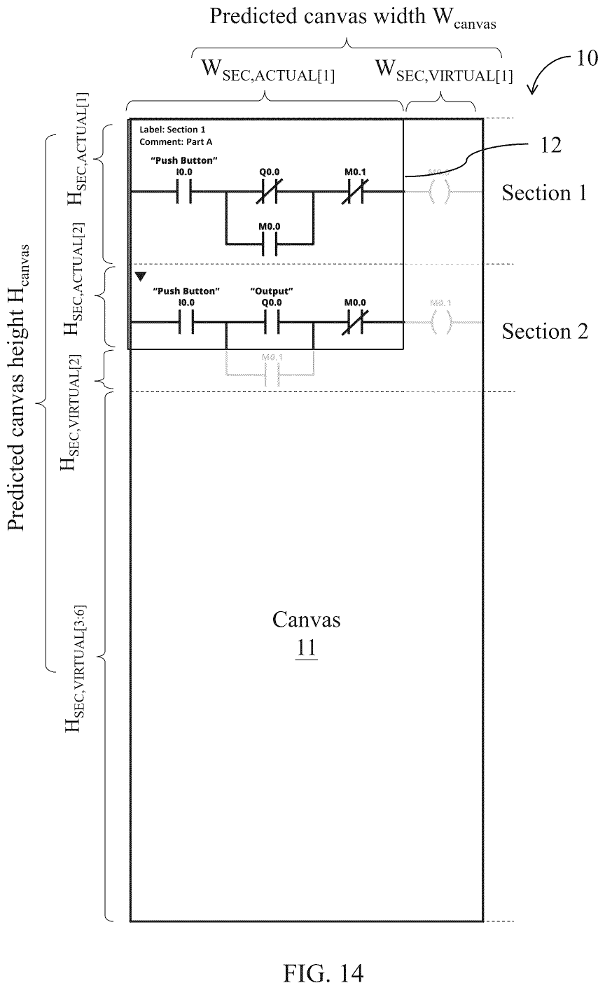

For example, in the example shown in FIG. 14, the predicted canvas height H_{canvas} of the canvas 11 can be calculated by adding up the predicted section height of all sections in the visual programming language file 10. Therefore, the predicted canvas height H_{canvas} equals to the sum of the actual height H_{SEC,ACTUAL[1]} of Section 1, the actual height H_{SEC,ACTUAL[2]} of Section 2, the virtual height H_{SEC, VIRTUAL[2]} of Section 2, and the virtual height H_{SEC, VIRTUAL[3:6]} of the rested sections. If the predicted section width of Section 1 is larger than the predicted section width of Section 2, the predicted canvas width W_{canvas} is equal to a sum of the actual width of Section 1 W_{SEC,ACTUAL[1]} and the virtual width W_{SEC, VIRTUAL[1]} of the Section 1.

In one embodiment, if a scrolling bar has not been generated, the system may generate a horizontal scrolling bar based on the predicted canvas width, and a vertical scrolling bar based on the predicted canvas height. In another embodiment, the system may adjust the scrolling bar based on the size and the position of the visible region relative to the canvas if the scrolling bar has been generated before. The predicted canvas height and the predicted canvas width are used for calculating the size of the canvas. In addition to scrolling bar, other user interfaces may be provided for users to determine the position of the visible region for displaying sections and objects of the visual programming language file. For example, a small preview image of the canvas may provide an overview of the entire canvas and allow the user to click or drag to select the visible region. Arrow icons for moving the visible region up, down, left, and right are alternatives as well.

In step S25, the system then displays the at least one visible object in the visible region. The at least one visible object may include only one visible object in one embodiment or multiple visible objects in another embodiment. In one embodiment, the system may generate a layout image based on a graph specification for each of the at least one visible object. The graph specification may be generated for each of the at least one visible object. The graph specification includes all the information necessary for a drawing routine to display the visible object, such as the actual height and actual width of the object, the object type, the object name, the object comment, the input or output variables, and the like. The graph specification of an object may be stored into the object information of the object in the content index. In one embodiment, the graph specification is store in the visible object list instead. In one embodiment, if the section label object and/or the section comment object of a section is visible, the system may also generate a graph specification for each of them. However, if the system is generated in step S24, this step may be omitted. In one embodiment, when an object-oriented programming language is employed to implement the system, programming objects may be utilized to implement the graph specification and various functions. Such programming objects are different from the objects of a visual programming language file to be displayed by the disclosed systems and methods. For example, the graph specification comprises a graphic data object and a location of the graphic data object. In one embodiment, the graphic data object may specify the brightness and/or the color of each pixel to be rendered to generate an image of the object. However, the graph specification may also be implemented by other data structures, such as database. After a graph specification is generated for each visible object, the drawing routine of the system generates and displays a layout image for all visible objects to be displayed in the visible region. As described before, some visible objects are completely displayed but other objects may be displayed partially.

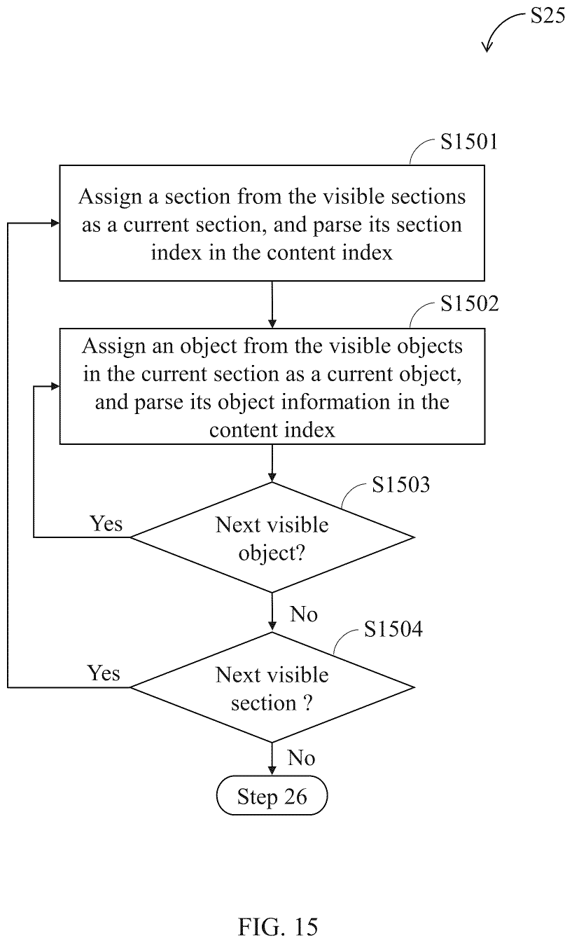

In one embodiment, step S25 may further comprise steps S1501 to S1504 as shown in FIG. 15. In step S1501, the system assigns a section from the visible sections as a current section and parses the section index of the current section in the content index for display. In one embodiment, the system may choose the section from the visible section list in the content index. In one embodiment, the system may parse the graphic specifications of the section label object and the section comment object, and render and display the section label object and section comment object. In one embodiment, the system may parse the section index to obtain the section background settings, and render and display the background of the visible sections.

Then in step S1503, the system assigns an object from the visible objects in the current section as a current object, and parses its object information in the content index for display. In one embodiment, the system may choose the object from the visible object list of the current section in the content index. In one embodiment, the system may parse the graph specification of the current object in the object information, and render and display the object.

The system determines whether there is a next visible object in the current section in step S1503. In one embodiment, the system may determine based on the visible object list in the content index. If so, the system returns to step S1502 and assign the next visible object as the current object and parse its object information. The steps S1502 to S1503 may be repeated until there is no more visible object in the current section. Then, the system may determine whether there is a next visible section in step S1504. In one embodiment, the system may determine whether there is a next visible section based on the visible section list in the content index. If so, the system returns to step S1501 to assign the next visible section as the current section and parses its section index. The steps S1501 to S1504 may be repeated until there is no more visible section. In another embodiment, instead of displaying the visible objects and/or the visible sections one by one, the system may generate and display an image of the entire visible region comprising all the visible objects and the visible sections at once based on the information parsed from steps S1501 to S1504.

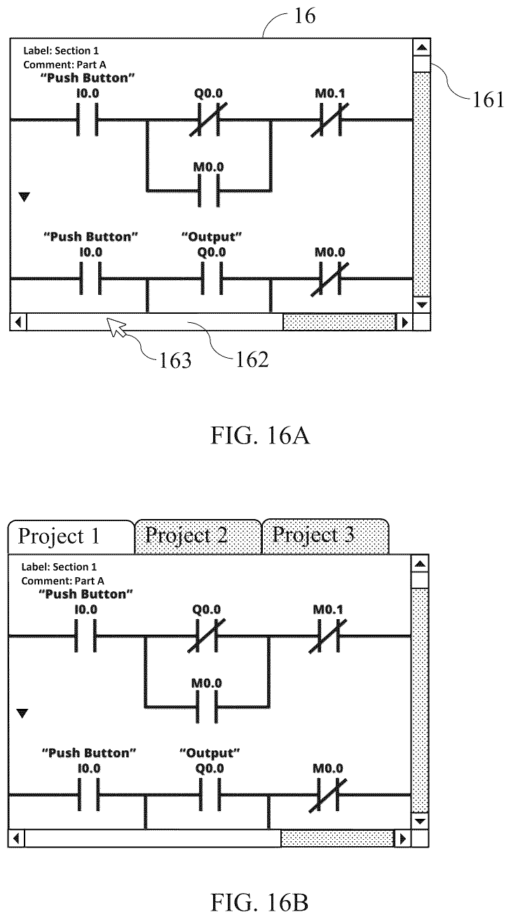

FIG. 16A depicts an image of a portion of the visual programming language file which is in the visible region based on a content index according to one embodiment of the disclosure. The visual programming language file 10 and the visible region 12 in FIG. 16A may be respectively similar to the visual programming language file 10 and the visible region 12 as shown in FIG. 1, 5, 8, 11 or 14. The content index may have a structure which is substantially similar to the structure of the content index IND_3 as shown in FIG. 3. In this embodiment, besides from the image 16 of the visible region 12, the system also generates a cursor 163 and a horizontal scrolling bar 162 and a vertical scrolling bar 161 of the visible region 12. The user may use the cursor 163 to move either the horizontal scrolling bar 162 or the vertical scrolling bar 161 to input the user command to change a position of the visible region 12. In another embodiment, the visible region 12 may be regarded as a sliding window of the canvas 11, the user command controls moving of the sliding window, such that the processor parses a portion of the content index corresponding to the sliding window, so as to draw and display an image corresponding to the portion of the content index. For the visual programming language file 10 with massive content, since only a portion of the content index that is required to be parsed and displayed in the sliding window, required running time and hardware resources are limited by the sliding window.

FIG. 16B depicts an image of a portion of a visual programming language file which is in a visible region based on a content index according to one embodiment of the disclosure. The image in FIG. 16B may be substantially similar to the image as shown in FIG. 16A. In this embodiment, the system also generates multiple element pages. In one embodiment, the file opened by the user comprises multiple visual programming language files, and each of the multiple element pages is generated for a visual programming language file in the file. That is, a file may be divided into multiple pages or chapters to adapt to certain software products (e.g., Page-Oriented CFC). Experiments show that operating performances of the processor and the memory device are approximately the same for multiple projects, since required running time and hardware resources are limited by the sliding window that is currently viewed by the programmer. That is to say, the loading time is approximately constant and irrelevant to how many files are running concurrently.

In step S26, the system may receive a user command to update the visible region to be displayed. Then, the system may determine the location of the new visible region on the current canvas. As described, various user interfaces may be used for users to select the new location of the visible region, including but not limited to scrolling bar, a small preview image of the canvas, arrow icons for moving the visible region up, down, left, and right and the like.

Then, the system may return to perform step S23, and repeat steps S23 to S25 to display the portion of the visual programming language file in the new visible region.

In Step S23, the system obtains and stores information related to at least one visible object to be displayed in the new visible region of the canvas into the content index. The system may first identify at least one visible object to be displayed in the new visible region based on the content index. As described before, the system may also perform steps S91 to S95 for the new visible region, which may be substantially similar to the descriptions aboveto display the initial visible region. For step S92, if the section index and the object information of the at least one visible object in the visible region has been obtained before, the system will not obtain it again. Also, if a portion of the new visible region is the same as a portion of the visible region displayed before, the actual height and actual width of the objects in this region should be calculated before, and hence will not need to be calculated again in step S93. In one embodiment, the system may identify these calculated objects by identifying their read state are true. However, in the embodiment where the system generates a graph specification comprising a graphic data object for each visible object, the system may still need to generate the graphic data object again for the new visible region since the graphic data objects may be released from the memory after the system receive a user command to move the visible region to a new location.

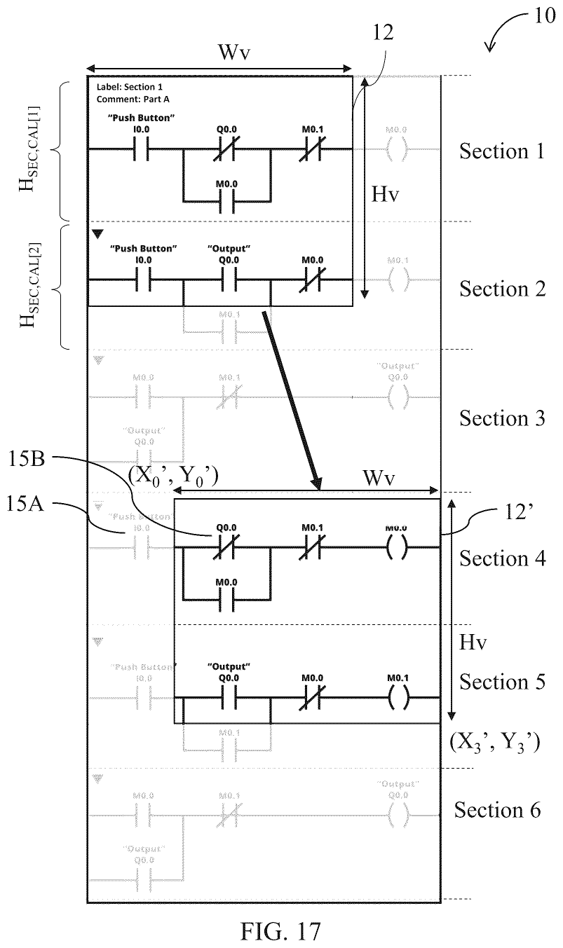

FIG. 17 depicts an example of a visible region updated by a user to display a new region of a visual programming language file according to one embodiment of the disclosure. The visible region 12 and the visual programming language file 10 shown in FIG. 17 may be substantially similar to the visible region 12 and the visual programming language file 10 shown in FIG. 1, 5, 8, 11 or 14. In this embodiment, the system receives a user command to move the visible region 12 to the new visible region 12′. The system may first identify the location of the new visible region. In the embodiment shown in FIG. 17, the system may need to identify the location of the visible region 12′ with a new origin and a new diagonal vertex of the visible region 12′ of (X₀′, Y₀′) and (X₃′, Y₃′), respectively. The system may also identify the visible height Hv and visible width Wv of the visible region 12′, which is the same as that of the visible region 12, respectively, in this embodiment. In this embodiment, the system conducts steps S1001 to S1009 as shown in FIG. 10 to perform step S23. In S1001, the system assign an initial section as a current section. The system may assign Section 1 as the initial section and proceed to step S1002. As described above, the system may determine whether the current section is outside of the visible region 12′ based on the predicted vertical coordinate of the current section and the vertical coordinate of the visible region. If so, the system returns to S1001 and assigns the next section as the current section. The predicted vertical coordinate of a section is calculated by adding up a predicted section height of each section before the section, the predicted section height of an unparsed section is a default section height, while the predicted section height of the parsed section is a calculated predicted section height which can be calculated as described above with regard to step S23. Therefore, when the default section height is 2 pixel units, the calculated predicted section height H_{SEC,CAL[1]} of Section 1 is 4 pixel units, and the calculated predicted section height H_{SEC,CAL[2]} of Section 2 is 3 pixel units. The predicted vertical coordinate of Section 1 to Section 6 is 0, 4, 7, 9, 11, 13 pixel units, respectively. Hence, for Section 1 to Section 3, the system only repeats steps S1001 to S1002 since each of them is outside of visible region, i.e. not a visible section. Then, when the current section is Section 4, the system determine it is a visible section and proceed to step S1003. Since Section 4 haven't been parsed before, the system has to obtain a section index of Section 4, and store it into the content index. The section index of Section 4 may comprise a vertical object number and a horizontal object number. In this embodiment, although there are a section label object and a section comment object in Section 4, the system may not obtain and store their information since they are set to be hide and hence invisible to the user. In Step S1004, the system may first assign an initial object, object 15A, as the current object, and determine it is outside of the visible region based on the default object width and the default object height in step S1005 since it is not parsed before. Then, the system returns to step S1004 and assign the next object, object 15B, as the current object, and determine it is not outside of the visible region, and hence is a visible object. In one embodiment, the system may add the object 15B into a new visible object list, which is established for the new visible region 12′. Since the object information of object 15B has not been obtained before, the system may need to obtain it which may comprise a variable of “QO.0”, and a type of “Boolean”. Then, the system may identify object 15B is also an unparsed object, which means the actual height and the actual width has not been calculated. In one embodiment, the system can identify based on the read state of object 15B of false. Hence, the system calculates its actual height and actual width. In one embodiment, the system set the read state of object 15B to be true after the calculation. The system may conduct the rest steps in S1001 to S1008 until all visible objects in all visible sections are identified. Then, the system store the section index, the object information, and the actual width and the actual height of all visible objects in all visible sections into the content index. However, in some embodiment, the system may store each of section index, the object information, and the actual width and the actual height of all visible objects in all visible sections into the content index upon obtaining it. The details about steps S1001 to S1009 may be omitted since the steps may be substantially similar to the description described above.

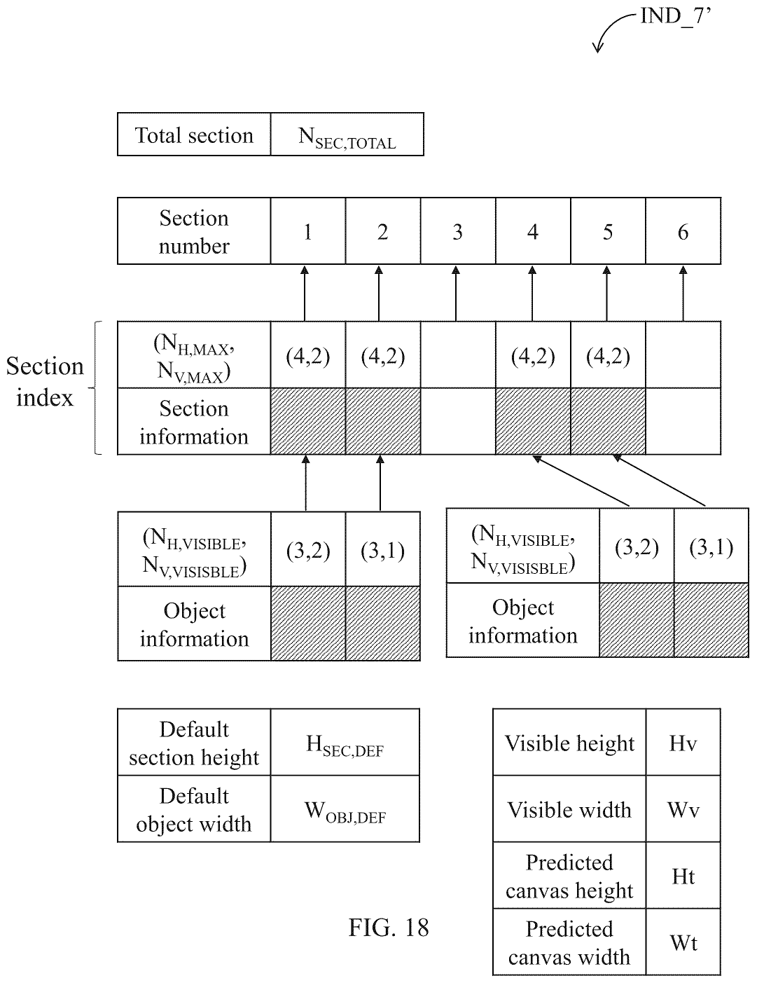

FIG. 18 depicts a schematic diagram of a content index according to an embodiment of the disclosure. The content index IND_7′ is an updated content index originated from the content index for displaying the visible region 12. As shown in FIG. 18, each of information related to Section 4 and Section 5 is obtained and stored in the content index IND_7 as a section index because each of them has a portion inside of the visible region 12′. Each information related to Section 1 and Section 2 is obtained and stored in the section index since a portion of them is displayed for the visible region 12, and remained in the content index. On the other hand, information related to Section 3 and Section 6 is not parsed and stored into content index because they haven't had a portion displayed before. Please be noted that a block in the content index IND_7′ refers to an allocated memory device space or register(s) during step execution, in which a block filled with dash pattern stores data, and an empty block does not store data.

Then the system may proceed to step S24 to calculate a predicted canvas height and a predicted canvas width of the canvas based on the content index. The details of performing step S24 to display the new visible region 12′ may be substantially similar to the that to display the visible region 12 described above.

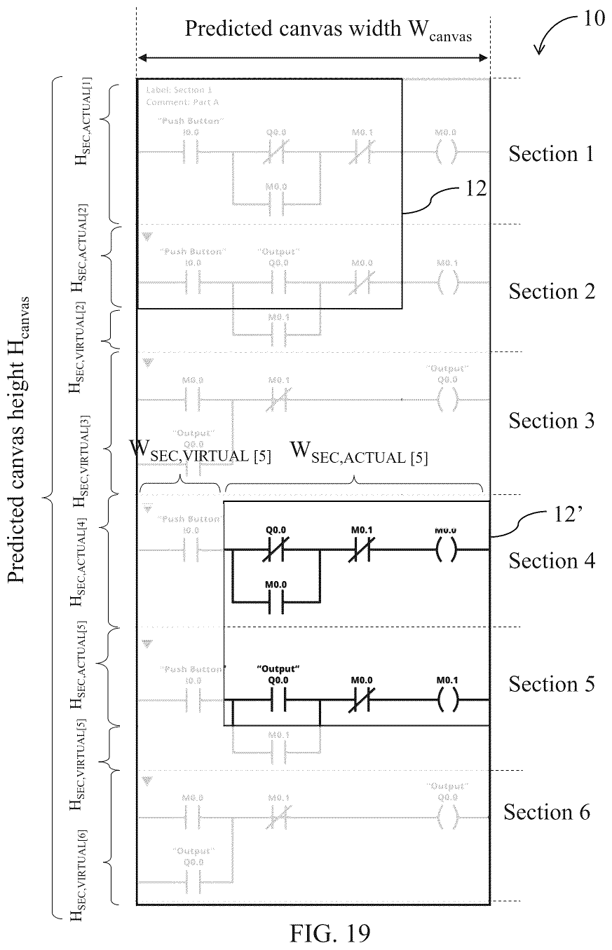

In the embodiment shown in FIG. 19, the predicted canvas height H_{canvas} can be calculated and determined by adding up the actual section height H_{SEC,ACTUAL[1]} of Section 1, the actual section height H_{SEC,ACTUAL[2]} of Section 2, the virtual section height H_{SEC,VIRTUAL[2]} of Section 2, the virtual section height H_{SEC,VIRTUAL[3]} of Section 3, the actual section height H_{SEC,ACTUAL[4]} of Section 4, the actual section height H_{SEC,ACTUAL[5]} of Section 5, and the virtual section height H_{SEC,VIRTUAL[5]} of Section 5. The predicted canvas width W_{canvas} can be determined as the section width of Section 5 since the section width of Section 5 is the largest among the section width of Section 4, the section width of Section 5, and the original predicted canvas width. Therefore, the predicted canvas width would be adjusted to the sum of the actual section width W_{SEC,ACTUAL[5]} and the virtual section width W_{SEC,VIRTUAL[5]} of Section 5.

In one embodiment, the system may generate a new horizontal scrolling bar or adjust the original horizontal scrolling bar based on the predicted canvas width, and generate a new vertical scrolling bar or adjust the original vertical scrolling bar based on the predicted canvas height. In another embodiment, the system may generate/adjust the scrolling bar based on the size and the position of the visible region relative to the canvas if the scrolling bar has been generated before. The predicted canvas height and the predicted canvas width are used for calculating the size of the canvas. As described above, besides scrolling bar, other user interfaces may be provided for users to determine the position of the visible region for displaying sections and objects of the visual programming language file can be alternative to the scrolling bar, and can be generate/adjusted as well.

Then, the at least one visible object in the visible region is displayed in S25. Details about S25 may be substantially similar to that described above. It is noted that since the system only need to display the image of the visible region, one can keep the generation speed of image relatively short even if there are more contents of visual programming language file to be parsed. In this embodiment, section 3 in FIG. 19 is not a visible section and is not parsed in the process of displaying the new visible region 12′. In addition, the actual heights and actual widths of the objects in section 3 are not calculated.

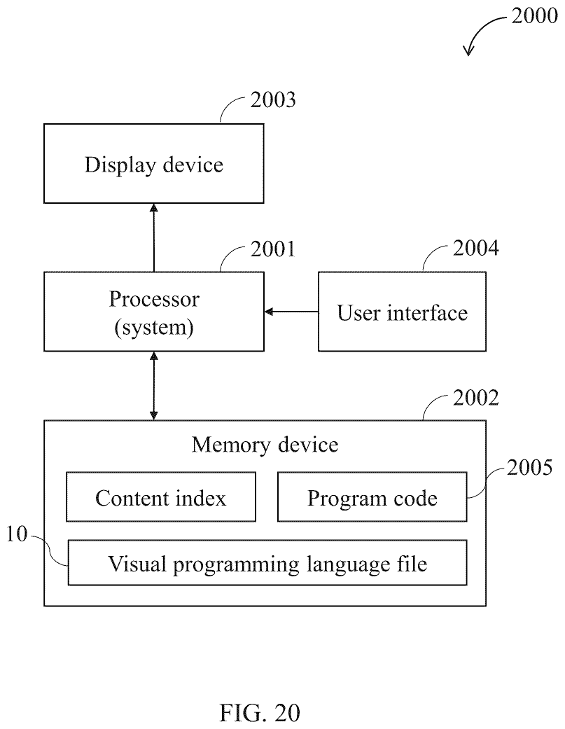

FIG. 20 depicts a schematic diagram of a display system 2000 according to an embodiment of the disclosure. The display system 2000 includes a processor 2001, a memory device 2002, a display device 2003, and an user interface 2004. The display device 2003 is configured to display an image corresponding to the visible region 12 and 12′. The user interface 2004 is configured to receive a user command. The memory device 2002 is configured to store the content index (e.g. the content index IND_3, IND_7, or IND_7′), the visual programming language file 10, and a program code 2005. The processor 2001 is connected to the display device 2003, the user interface 2004 and the memory device 2002, wherein the program code 2005 is configured to instruct the processor 2001 executing steps of the method and associated sub-processes to generate the content index, the image corresponding to the visible region 12, and a new image corresponding to a new visible region 12′ according to the user command. In one embodiment, the memory device 2002 may be at least one of a Random Access Memory device (RAM), Read-Only Memory device (ROM), Electrically-Erasable Programmable Read-Only Memory device (EEPROM), flash memory device, Compact Disc Read-Only Memory device (CD-ROM), Digital Versatile Disc (DVD) or optical disc storage device, magnetic disk, disk, disk storage device or other magnetic storage device. In one embodiment, the program code 2005 can be written by various programming languages, such as Extensible Markup Language (XML), JavaScript Object Notation (JSON), C #, C++, Java, Python, Objective-C, and the like.

The advantage of this disclosure is to shorten the time taken to display objects in a visible region after the system opens a visual programming language file with massive amount of contents while preserving flexibility to display the objects in a user-friendly manner. The method and system described above does not generate an image for each object of the visual programming language file right after the system opens such file because generating images for all objects is very time consuming. Rather, the disclosed method and system identifies the objects to be displayed in a visible region based on content index and generates images only for those objects. Moreover, after users select a new visible region, the images created for display objects in the original visible region may be removed or deleted to release more memory space. The system identifies the objects to be displayed in a visible region and calculates their actual object heights and the actual object widths based on object information, such as label, input/output variables, or comment. As a result, these objects may be displayed at an appropriate size to include all related information. Without such dynamic calculation, objects would be displayed in a static manner, and hence content of the object may not be fully displayed, making it more challenging for users to read and comprehend the content of the visual programming language file. To display a new visible region after an original visible region, the system calculates the actual height and the actual width of the visible objects in the new visible region. Thus, the system does not parse sections between the original visible region and the new visible region. In addition, to shorten the process time, the actual height and the actual width of the objects between the original visible region and the new visible region are not calculated.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein but is to be accorded the widest scope consistent with the principles and novel features disclosed herein. It is contemplated that additional embodiments are within the spirit and true scope of the disclosed subject matter. Thus, it is intended that the present invention covers modifications and variations that come within the scope of the appended claims and their equivalents.

1. A method for displaying a portion of a visual programming language file having multiple objects arranged in multiple sections, comprising:
(1) establishing a content index from the visual programming language file;
(2) obtaining and storing information related to at least one visible object in at least one visible section to be displayed in a visible region of a canvas into the content index;
(3) calculating a predicted canvas height and a predicted canvas width of the canvas based on the content index; and
(4) displaying the at least one visible object in the visible region.

2. The method of claim 1, wherein the step (1) comprises the steps of:
(1.1) parsing the visual programming language file to obtain and store a total section number into the content index;
(1.2) determining a location of the visible region;
(1.3) identifying one or more potential visible sections expected to be displayed in the visible region based on a default section height; and
(1.4) obtaining and storing a horizontal object number, a vertical object number, and related object structural information of each of the one or more potential visible sections into the content index.

3. The method of claim 2, before obtaining and storing information related to the at least one visible object to be displayed in the visible region of the canvas into the content index, further comprising:
establishing the canvas having an initial canvas height as the predicted canvas height and an initial canvas width as the predicted canvas width, based on the content index.

4. The method of claim 3, wherein the initial canvas height is the total section number multiplied by the default section height and the initial canvas width is a largest horizontal object number of the one or more potential visible sections multiplied by a default object width.

5. The method of claim 1, wherein the step (2) comprises steps of:
(2.1) identifying the at least one visible object in at least one visible section to be displayed in the visible region;
(2.2) obtaining section index and object information of the at least one visible object in the at least one visible section;
(2.3) calculating an actual width and an actual height of the at least one visible object in the at least one visible section based on the object information;
(2.4) repeating steps (2.1) to (2.4) until all visible objects in all visible sections are identified if the at least one visible object includes multiple visible objects and the at least one visible section includes multiple visible sections; and
(2.5) storing the section index, the object information, and the actual width and the actual height of all visible objects in all visible sections into the content index.

6. The method of claim 5, wherein, at step (2.1), the at least one visible section is first identified by the steps of:
determining a vertical coordinate of the visible region on the canvas;
calculating a predicted vertical coordinate of the multiple sections based on the content index; and
identify the at least one section having a predicted vertical coordinate corresponding to the vertical coordinate of the visible region on the canvas.

7. The method of claim 6, wherein the predicted vertical coordinate of a section is calculated by adding up a predicted section height of each section before the section, the predicted section height of an unparsed section is a default section height, the predicted section height of a parsed section is a sum of a predicted row height of each row in the parsed section, the predicted row height of a row without a displayed object is a default object height, and the predicted row height of a row with at least one displayed object is the largest actual object height.

8. The method of claim 6, wherein, at step (2.1), the at least one visible object is identified by the steps of:
determining a horizontal coordinate of the visible region on the canvas;
calculating a predicted horizontal coordinate and a predicted vertical coordinate of the multiple objects in the at least one visible section based on the content index; and
identify the at least one visible object having a predicted horizontal coordinate and a predicted vertical coordinate corresponding to the horizontal coordinate and the vertical coordinate of the visible region on the canvas.

9. The method of claim 8, wherein the predicted vertical coordinate of an object in one of the at least one visible section is calculated by adding up a predicted section height of each section before the section and a predicted row height of each row before the object in the section, each section is a parsed section or an unparsed section, the predicted section height of an unparsed section is a default section height, the predicted section height of a parsed section is a sum of a predicted row height of each row in the parsed section, the predicted row height of a row without a displayed object is a default object height, and the predicted row height of a row with at least one displayed object is the largest actual object height.

10. The method of claim 9, wherein the predicted horizontal coordinate of an object in one of the at least one visible section is calculated by adding up a predicted object width of each object before the object, each object is either a displayed object or a non-displayed object, the predicted object width of the displayed object is the actual object width, and the predicted object width of the non-displayed object is a default object width.

11. The method of claim 1, wherein the step (2) comprises the steps of:
(2a) assigning an initial section as a current section;
(2b) determining if the current section is outside of the visible region;
(2c) if the current section is not outside of the visible region, obtain section index of the current section which is the at least one visible section;
(2d) assigning an initial object in the current section as a current object;
(2e) determining if the current object of the current section is outside of the visible region;
(2f) if the current object is not outside of the visible region, obtain object information of the current object which is the at least one visible object, and calculate an actual width and an actual height of the current object;
(2g) assigning a next object as the current object and repeating the steps (2.5) to (2.7) until all visible objects in the current section are identified; and
(2h) assigning a next section as the current section and repeating the steps (2.2) to (2.8) until all visible sections are identified; and
(2i) storing the section index, the object information, and the actual width and the actual height of all visible objects in all visible sections into the content index.

12. The method of claim 11, wherein the step (2c) further comprises:
setting a read state of the current section to be true.

13. The method of claim 11, wherein the step (2f) further comprises:
setting a read state of the current object to be true.

14. The method of claim 11, wherein the step (2f) further comprises:
generating a graph specification for the current object, the graph specification including
the actual height, the actual width, an object type, an object name, an input variable, and an output variable of the current object.

15. The method of claim 11, wherein the step (2g) further comprises:
calculating a predicted section width of the current section by adding up a predicted object width of each object counted for the horizontal object number;
wherein each object is either a displayed object or a non-displayed object, the predicted width of the displayed object is the actual object width, and the predicted width of the non-displayed object is a default object width; and
calculating a predicted section height of the current section by adding up a predicted row height of each row in the current section;
wherein the predicted row height of a row without a displayed object is a default object height and the predicted row height of a row with at least one displayed object is a largest actual object height of the row.

16. The method of claim 1, wherein the step (3) comprises the steps of:
(3.1) adding up a predicted section height of each section in the visual programming language file to obtain the predicted canvas height; and
(3.2) comparing a predicted section width of each visible section against a current maximum section width; and
(3.3) if the largest predicted section width of each visible section is larger than the current maximum section width, storing the largest predicted section width of each visible section as a new maximum section width for the predicted canvas width.

17. The method of claim 1, wherein step (3) further comprises:
generating a horizontal scrolling bar based on the predicted canvas width; and
generating a vertical scrolling bar based on the predicted canvas height.

18. The method of claim 1, wherein the step (4) further comprises:
generating a layout image based on a graph specification for each of the at least one visible object.

19. A display system for displaying a portion of a visual programming language file having multiple objects arranged in multiple sections, comprising:
a display device configured to display an image corresponding to at least one visible object in a visible region of a canvas;
a user interface configured to receive a user command;
a memory device configured to store the visual programming language file, a content index of the visual programming language file, and a program code; and
a processor connected to the display device, the user interface and the memory device, wherein the program code is configured to instruct the processor to perform operations comprising:
(1) establishing the content index from the visual programming language file;
(2) obtaining and storing information related to the at least one visible object in at least one visible section to be displayed in a visible region of the canvas into the content index;
(3) calculating a predicted canvas height and a predicted canvas width of the canvas based on the content index; and
(4) displaying the at least one visible object in the visible region.
